(19) United States
(12) Patent Application Publication
(10) Pub. No.: US 2022/0025687 A1
(43) Pub. Date: Jan. 27, 2022

(54) WINDOW REGULATOR

(71) Applicant: Johnan Manufacturing Inc., Nagano (JP)

(72) Inventors: Tomotaka SHIROMA, Nagano (JP); Kousuke FURUICHI, Nagano (JP)

(21) Appl. No.: 17/369,110

(22) Filed: Jul. 7, 2021

(51) Int. Cl. E05D 15/16; B60J 1/17

(52) U.S. Cl. CPC E05D 15/165; B60J 1/17; E05Y 2201/64; E05Y 2900/55; E05Y 2201/474; E05Y 2800/108; E05Y 2201/654

(57) ABSTRACT

A window regulator includes a carrier plate, a wire to pull the carrier plate, a slide member including a main body attached to an end of the wire and a flange at a base end of the main body, and a spring to apply a tensile force to the wire. The carrier plate includes a housing portion including a bottom surface, the housing portion accommodating the spring. A grease storage portion for storing grease is formed between the flange and the bottom surface. A protruding portion is formed on one surface out of the bottom surface and the end face so as to protrude from the one surface and comes into contact with the other surface out of the bottom surface and the end face to restrict an advancing position of the slide member. The protruding portion is deformed by the contact such that a protruding length thereof is reduced.

### CROSS-REFERENCES TO RELATED APPLICATIONS

The present patent application claims the priority of Japanese patent application No. 2020/125548 filed on Jul. 22, 2020, and the entire contents of Japanese patent application No. 2020/125548 are hereby incorporated by reference.

### TECHNICAL FIELD

The present invention relates to a window regulator.

### BACKGROUND ART

A wire-type window regulator is known which is provided with a carrier plate to raised/lowered by wire-driving to raise/lower a window glass (see Patent Literature 1). The window regulator includes a carrier plate that moves with a window glass, wires that pull the carrier plate, wire ends fixed to carrier plate-side ends of the wires, slide bushes engaging and holding the wire ends, and coil springs for applying a tensile force to the wires. The carrier plate also has housing portions (wire end housing portions) for housing the slide bushes and the coil springs, and lead-out grooves for leading out the wires from bottom surfaces of the housing portions toward the outside of the carrier plate. In this window regulator, each slide bush is arranged in the corresponding housing portion so that the slide bush can advance and retreat and its end face faces the bottom surface of the housing portion, and the coil spring is arranged in a compressed state between a flange of the slide bush and the bottom surface of the housing portion. Thus, the flange of the slide bush receives a force applied in a direction separating away from the bottom surface and slack of the wire is suppressed.

### CITATION LIST

### Patent Literature

Patent Literature 1: JP 2018/066192 A

### SUMMARY OF INVENTION

The known window regulator described above may cause a problem that when the window regulator is used for a long period of time, grease (lubricant oil) for suppressing abnormal noise flows out from the lead-out grooves and is depleted and generation of abnormal noise thus cannot be suppressed.

In detail, the slide bush is arranged in the housing portion so that the slide bush can advance and retreat and its end face faces the bottom surface of the housing portion, as described above. Therefore, during the raising/lowering operation of the wind regulator, the end face of the slide bush comes into contact with the bottom surface of the housing portion against the force applied by the coil spring, and abnormal noise may be generated due to the contact. To address this problem, grease can be injected in the housing portion so that abnormal noise can be suppressed by the grease supplied around the end face of the slide bush. However, in the known window regulator, the end face of the slide bush actively pushes the grease therearound into the lead-out groove in the similar manner to a syringe when the end face of the slide bush comes into contact with the bottom surface of the housing portion, and most of the grease around the end face of the slide bush flows out from the lead-out groove to the outside. By repeating the contact, the grease supplied around the end face of the slide bush may be depleted and generation of abnormal noise thus may not be suppressed. As a result, generation of abnormal noise may not be suppressed when the wind regulator is used for a long period of time.

It is an object of the invention to provide a window regulator that is capable of suppressing the generation of abnormal noise even if the wind regulator has been used for a long period of time.

According to an embodiment of the invention mentioned above, a window regulator comprises:
a carrier plate to be attached to a vehicle window glass;
a wire to pull the carrier plate;
a slide member comprising a main body attached to an end of the wire and a flange at a base end of the main body; and
a spring to apply a tensile force to the wire,
wherein the carrier plate comprises a housing portion formed in a bottomed hole shape comprising a bottom surface on which a lead-out portion for leading out the wire is formed, the housing portion accommodating the slide member so that the slide member can advance and retreat and an end face of the main body faces the bottom surface, and the housing portion accommodating the spring in a compressed state between the flange and the bottom surface,
wherein a grease storage portion for storing grease is formed between the flange and the bottom surface,
wherein a protruding portion is formed on one surface out of the bottom surface and the end face so as to protrude from the one surface and comes into contact with the other surface out of the bottom surface and the end face to restrict an advancing position of the slide member, and
wherein the protruding portion is deformed by the contact such that a protruding length thereof is reduced.

### Advantageous Effects of Invention

According to an embodiment of the invention, a window regulator can be provided that is capable of suppressing the generation of abnormal noise even if the wind regulator has been used for a long period of time.

### BRIEF DESCRIPTION OF DRAWINGS

FIG. 1 is a general schematic diagram illustrating a window regulator in an embodiment of the present invention and a vehicle door on which the window regulator is provided.

FIG. 2 is a front view showing the window regulator.

FIG. 3 is a partial cross-sectional view showing a portion around a carrier plate.

FIG. 4A is a front view showing the carrier plate.

FIG. 4B is a plan view thereof,

FIG. 4C is a back view thereof.

FIG. 5A is a cross sectional view taken along line A-A′ showing a portion around a descending-side housing portion in a state where a descending-side slide bush is separated from the bottom surface.

FIG. 5B is a cross sectional view taken along line A-A′ showing the portion around the descending-side housing portion in a state where the descending-side slide bush is close to the bottom surface.

FIG. 5C is a cross sectional view taken along line A-A′ showing the portion around the descending-side housing portion and also showing grease in a state where the descending-side slide bush is close to the bottom surface.

FIG. 6A is a cross sectional view taken along line A-A′ showing a restriction protrusion.

FIG. 6B is a plan view showing the restriction protrusion.

FIG. 6C is a cross sectional view taken along line A-A′ showing a flow of the grease.

FIG. 7A is a cross sectional view taken along line A-A′ showing the portion around the descending-side housing portion in the initial state.

FIG. 7B is a cross sectional view taken along line A-A′ showing the portion around the descending-side housing portion after the slide bush comes into contact with the restriction protrusion 10,000 times.

FIG. 7C is a cross sectional view taken along line A-A′ showing the portion around the descending-side housing portion after the slide bush comes into contact with the restriction protrusion 20,000 times.

FIG. 8A is a cross sectional view taken along line A-A′ showing a first modification of the restriction protrusion.

FIG. 8B is a plan view showing a second modification of the restriction protrusion.

FIG. 8C is a plane view showing a third modification of the restriction protrusion.

### DESCRIPTION OF EMBODIMENTS

A window regulator in an embodiment of the invention will be described below in reference to the appended drawings. This window regulator is a raising/lowering device that is installed in a door panel of an automobile (a vehicle) and raises/lowers a window glass of a door provided on the automobile. In this window regulator, particularly a grease supply structure inside the carrier plate is improved so that generation of abnormal noise can be suppressed even when the wind regulator is used for a long period of time. Hereinafter, an ascending/descending direction, an ascending direction and a descending direction of the window glass are simply referred to as the ascending/descending direction, the ascending direction and the descending direction. In addition, left, right, front, rear, up and down used in the following description are as defined in each drawing.

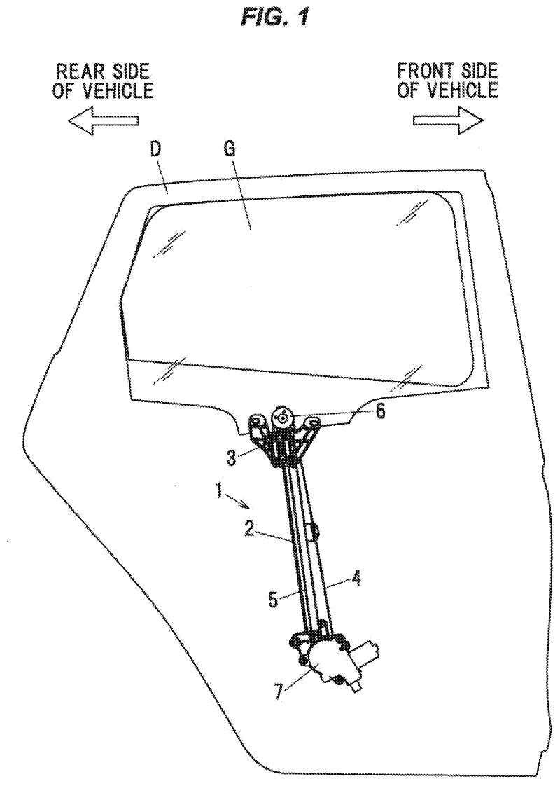

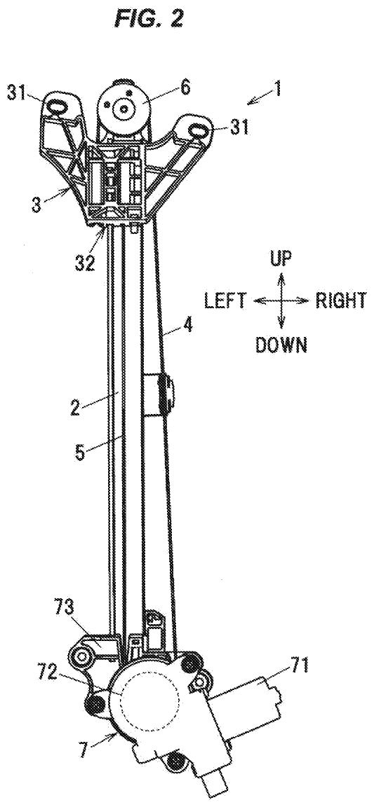

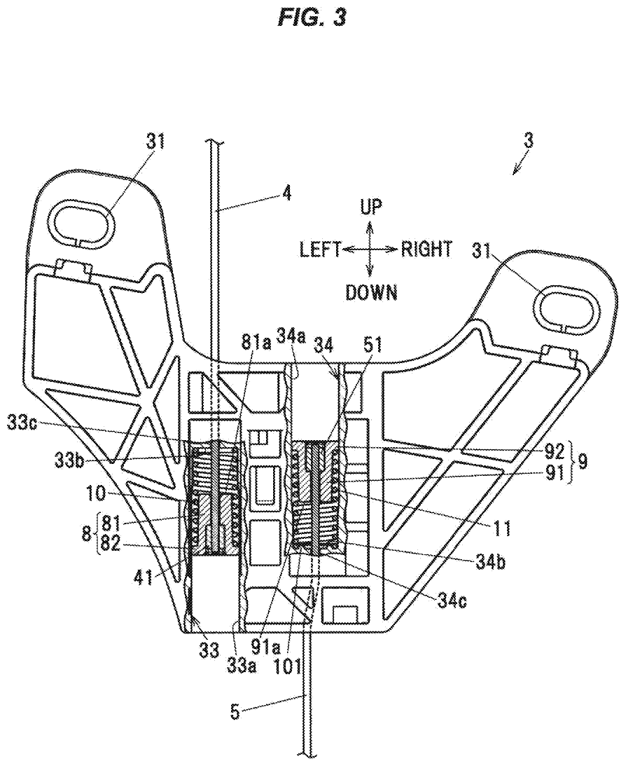

As shown in FIGS. 1 and 2, a window regulator 1 is installed inside a door panel (not shown) and includes a guide rail 2 provided along the ascending/descending direction of a window glass G, a carrier plate 3 to which the window glass G is attached and which moves while sliding on the guide rail 2, an ascending-side wire 4 and a descending-side wire 5 (the wire) that pull the carrier plate 3, a pulley 6 provided at an upper end of the guide rail 2 to change the direction of the ascending-side wire 4, and a drive unit 7 provided to take up and feed out the ascending-side wire 4 and the descending-side wire 5. A shown in FIG. 3, the window regulator 1 also includes an ascending-side slide bush 8 attached to an end of the ascending-side wire 4 on the carrier plate 3 side, an ascending-side spring 10 for applying a tensile force to the ascending-side wire 4 via the ascending-side slide bush 8, a descending-side slide bush 9 (the slide member) attached to an end of the descending-side wire 5 on the carrier plate 3 side, and a descending-side spring 11 for applying a tensile force to the descending-side wire 5 via the descending-side slide bush 9. That is, the window regulator 1 is a so-called wire-type single rail window regulator 1.

As shown in FIGS. 1 and 2, the guide rail 2 is formed by bending a long metal plate at a predetermined curvature and is arranged so as to tilt to the rear side in a vehicle longitudinal direction with respect to a door D. The guide rail 2 supports the carrier plate 3 so as to be ascendable/descendible.

The ascending-side wire 4 is attached to the carrier plate 3 at one end, passes through the pulley 6, and is coupled to a drum 72 of the drive unit 7 (described later) at the other end. Meanwhile, the descending-side wire 5 is attached to the carrier plate 3 at one end and is coupled to the drum 72 at the other end.

The drive unit 7 has a motor 71 with reducer, the cylindrical drum. 72 that is rotationally driven by the motor 71 and rotates to take up and feed out the ascending-side wire 4 and the descending-side wire 5, and a housing 73 that is provided at a lower end of the guide rail 2, holds the motor 71 and also covers the drum 72.

When the motor 71 is driven in forward, the drum 72 rotates in the forward direction and takes up the ascending-side wire 4 while feeding out the descending-side wire 5. Thus, the carrier plate 3 is pulled by the ascending-side wire 4 and moves in the ascending direction. As a result, the window glass G attached to the carrier plate 3 ascends. On the other hand, when the motor 71 is driven in reverse, the drum 72 rotates in the reverse direction and takes up the descending-side wire 5 while feeding out the ascending-side wire 4. Thus, the carrier plate 3 is pulled by the descending-side wire 5 and moves in the descending direction. As a result, the window glass G attached to the carrier plate 3 descends.

As shown in FIG. 3, the ascending-side slide bush 8 is formed of a resin and has a cylindrical main body 81 and a flange 82 radially protruding from a base end (a lower end in FIG. 3) of the main body 81. An ascending-side wire end 41 formed at an end of the ascending-side wire 4 is engaged with and held inside the main body 81. The ascending-side slide bush 8 is attached to the end of the ascending-side wire 4 by engagement between the ascending-side wire end 41 and the main body 81.

The ascending-side spring 10 is composed of a coil spring (a helical spring). The ascending-side spring 10 is arranged such that the main body 81 of the ascending-side slide bush 8 is inserted thereinto and a lower end thereof is in contact with the flange 82 of the ascending-side slide bush 8.

The descending-side slide bush 9 is formed of a resin and has a cylindrical main body 91, and a flange 92 radially protruding from a base end (an upper end in FIG. 3) of the main body 91. A descending-side wire end 51 formed at an end of the descending-side wire 5 is engaged with and held inside the main body 91. The descending-side slide bush 9 is attached to the end of the descending-side wire 5 by engagement between the descending-side wire end 51 and the main body 91.

The descending-side spring 11 is composed of a coil spring. The descending-side spring 11 is arranged such that the main body 91 of the descending-side slide bush 9 is inserted thereinto and an upper end thereof is in contact with the flange 92 of the descending-side slide bush 9.

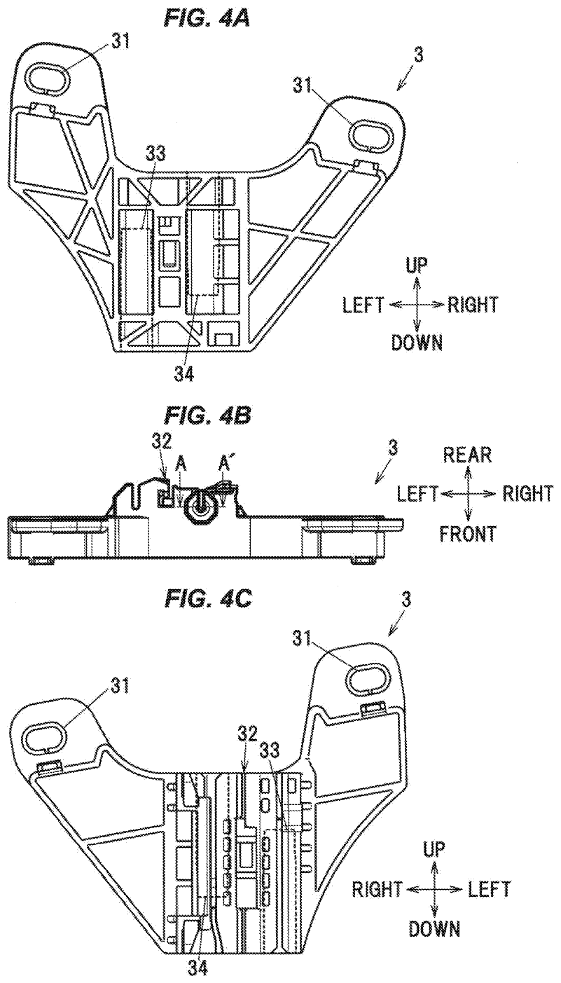

Next, the carrier plate 3 will be described in reference to FIGS. 3 and 4. As shown in FIGS. 3 and 4, the carrier plate 3 is formed of a resin and has two (tight and left) attachment holes 31, 31 for attaching the window glass G, a rail attachment portion 32 arranged at substantially the center on the rearward surface side (on the far side in FIG. 3 an ascending-side housing portion 33 arranged on the left side of the rail attachment portion 32 and accommodating the ascending-side slide bush 8 and the ascending-side spring 10, and a descending-side housing portion 34 (the housing portion) arranged on the right side of the rail attachment portion 32 and accommodating the descending-side slide bush 9 and the descending-side spring 11. The carrier plate 3 is formed of a resin softer than the ascending-side slide bush 8 and the descending-side slide bush 9. However, the carrier plate 3 may be formed of a resin harder than the ascending-side slide bush 8 and the descending-side slide bush 9, or may be formed of a resin having the same hardness as the ascending-side slide bush 8 and the descending-side slide bush 9.

The attachment holes 31, 31 are for bolting glass holders (not shown) that are fixed to the window glass G. The window glass G is attached to the carrier plate 3 via the glass holders by fastening the glass holders with bolts inserted into the attachment holes 31, 31.

The rail attachment portion 32 is slidably attached to the guide rail 2. That is, the carrier plate 3 is supported on the guide rail 2 by the rail attachment portion 32 so as to be ascendable/descendible.

As shown in FIG. 3, the ascending-side housing portion 33 is formed in a bottomed hole shape having an octagonal prism-shaped hollow portion with a bottom on the upper side, and has an inner surface 33a and a bottom surface 33b. The ascending-side housing portion 33 accommodates the ascending-side slide bush 8 inside the hollow portion so that the ascending-side slide bush 8 can advance and retreat in the up-down direction and an end face 81a (an upper surface) of the main body 81 faces the bottom surface 33b. The ascending-side housing portion 33 also accommodates the ascending-side spring 10 in a compressed state between the flange 82 of the ascending-side slide bush 8 and the bottom surface 33b. Furthermore, a lead-out groove 33c having a bottom on the front side (on the near side in FIG. 3) is formed on the bottom surface 33b of the ascending-side housing portion 33 to lead the ascending-side wire 4 out of the carrier plate 3. The ascending-side spring 10 blocked by the bottom surface 33b downwardly presses the flange 82 of the ascending-side slide bush 8 inside the ascending-side housing portion 33, and a tensile force is thereby applied to the ascending-side wire 4 via the ascending-side slide bush 8. As a result, slack of the ascending-side wire 4 is suppressed.

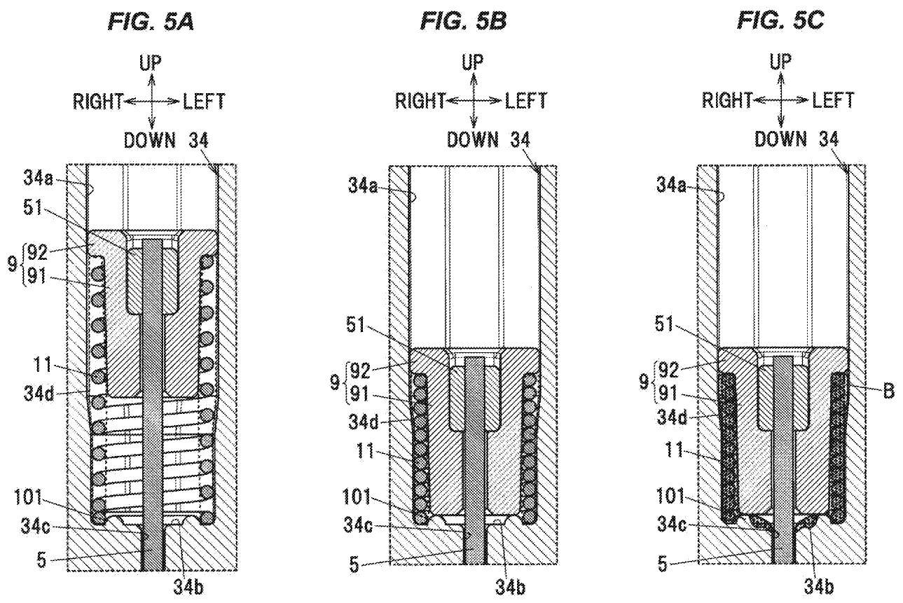

As shown in FIGS. 3 and 5, the descending-side housing portion 34 is formed in a bottomed hole shape having an octagonal prism-shaped hollow portion with a bottom on the lower side, and has an inner surface 34a and a bottom surface 34b. The descending-side housing portion 34 accommodates the descending-side slide bush 9 inside the hollow portion so that the descending-side slide bush 9 can advance and retreat in the up-down direction and an end face 91a (a lower surface) of the main body 91 faces the bottom surface 34b. The descending-side housing portion 34 also accommodates the descending-side spring 11 in a compressed state between the flange 92 of the descending-side slide bush 9 and the bottom surface 34b. Furthermore, a lead-out groove 34c (the lead-out portion) having a bottom on the front side (on the near side in FIG. 3) is formed on the bottom surface 34b of the descending-side housing portion 34 to lead the descending-side wire 5 out of the carrier plate 3. The descending-side spring 11 blocked by the bottom surface 34b upwardly presses the flange 92 of the descending-side slide bush 9 inside the descending-side housing portion 34, and a tensile force is thereby applied to the descending-side wire 5 via the descending-side slide bush 9. As a result, slack of the descending-side wire 5 is suppressed.

Inside the descending-side housing portion 34, the descending-side slide bush 9 is located close to the bottom surface 34b against a force applied by the descending-side spring 11 as shown in FIGS. 5B and 5C when the descending-side wire 5 is pulled, and the descending-side slide bush 9 is located at a distance from the bottom surface 34b due to the force applied by the descending-side spring 11 as shown in FIG. 5A when the descending-side wire 5 is not pulled. Thus, the descending-side slide bush 9 repeatedly approaches the bottom surface 34b and recedes from the bottom surface 34b during the raising/lowering operation (mainly the lowering operation) of the wind regulator 1.

Meanwhile, in the descending-side housing portion 34, a grease storage portion 34d storing grease B for suppressing abnormal noise is formed between the flange 92 of the descending-side slide bush 9 and the bottom surface 34b, as shown in FIG. 5. Precisely, the grease storage portion 34d is formed by the flange 92 of the descending-side slide bush 9, the outer surface of the main body 91 of the descending-side slide bush 9, the bottom surface 34b of the descending-side housing portion 34 and the inner surface 34a of the descending-side housing portion 34. As shown in FIG. 5C, the grease B is stored in the grease storage portion 34d. This grease B is to suppress generation of abnormal noise at the time that the descending-side slide bush 9 comes into contact with a portion around the bottom surface 34b of the descending-side housing portion 34. As described above, the descending-side slide bush 9 comes close to the bottom surface 34b of the descending-side housing portion 34 when the carrier plate 3 is pulled by the descending-side wire 5. At this time, the flange 92 of the descending-side slide bush 9 pushes out the grease B in the grease storage portion 34d, and the grease B in the grease storage portion 34d is thereby supplied between the end face 91a (of the main body 91) of the descending-side slide bush 9 and the bottom surface 34b.

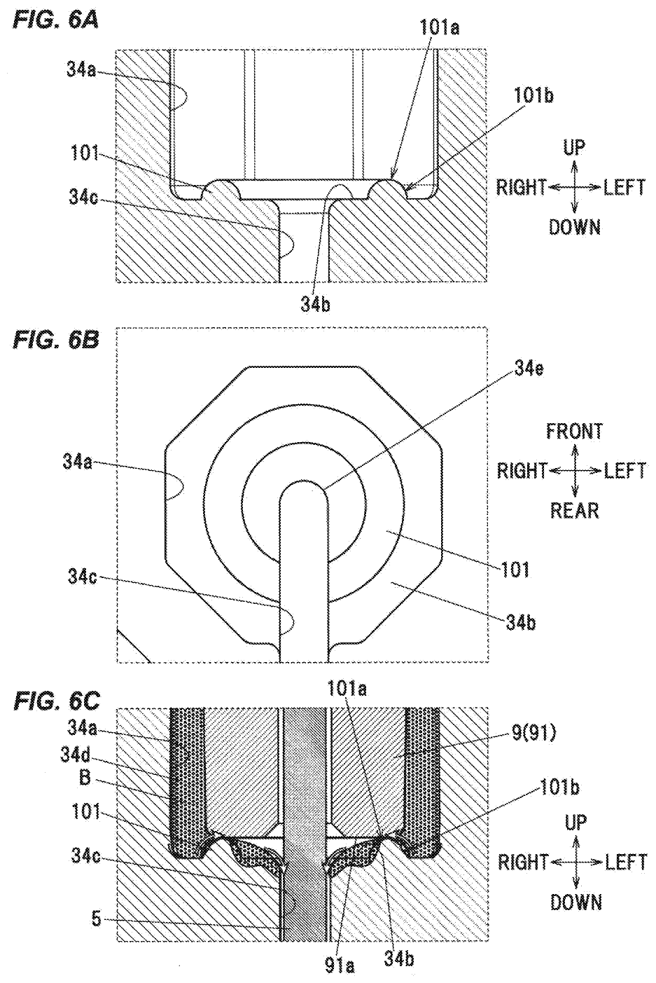

On the bottom surface 34b of the descending-side housing portion 34, a restriction protrusion 101 (the protruding portion) protruding from the bottom surface 34b is formed adjacent to the grease storage portion 34d, as shown in FIG. 6. The restriction protrusion 101 is formed to have a semicircular cross-sectional shape and extends in an annular shape with a cut-out portion. In detail, as shown in FIG. 6B, the restriction protrusion 101 is formed in an annular shape that surrounds a bottom portion 34e of the lead-out groove 34c located at the center of the bottom surface 34b and has a cut-out portion at the intersection with the lead-out groove 34c. When the descending-side slide bush 9 comes close to the bottom surface 34b of the descending-side housing portion 34, the restriction protrusion 101 comes into contact with the end face 91a of the descending-side slide bush 9 and restricts an advancing position (limits the lowest position) of the descending-side slide bush 9. That is, by a protruding length of the restriction protrusion 101, the advancing position of the descending-side slide bush 9 at the time that the descending-side slide bush 9 comes close to the bottom surface 34b of the descending-side housing portion 34 is controlled. As a result, the distance between the flange 92 of the descending-side slide bush 9 and the bottom surface 34b and the capacity of the grease storage portion 34d formed between the flange 92 and the bottom surface 34b at the time that the descending-side slide bush 9 comes close to the bottom surface 34b are controlled.

As shown in FIGS. 6A and 6C, the restriction protrusion 101 has an apex 101a serving as a contact surface to be in contact with the descending-side slide bush 9 and a lateral surface 101b formed as an inclined surface for guiding the grease B stored in the grease storage portion 34d to the apex 101a. As shown in FIG. 6C, when the descending-side slide bush 9 comes close to the bottom surface 34b of the descending-side housing portion 34 and the grease B stored in the grease storage portion 34d is supplied between the end face 91a of the descending-side slide bush 9 and the bottom surface 34b, the supplied grease B reaches the apex 101a via the lateral surface 101b of the restriction protrusion 101 and is supplied between the end face 91a of the descending-side slide bush 9 and the restriction protrusion 101. Due to repeat of the approach and the recession of the descending-side slide bush 9, the supplied grease B reaches the lead-out groove 34c via the bottom surface 34b on the inner side of the restriction protrusion 101 and flows out of the carrier plate 3 through the lead-out groove 34c.

The restriction protrusion 101 is compressively deformed by the contact with the descending-side slide bush 9 such that the protruding length (the height) with respect to bottom surface 34b is reduced. That is, due to repeated contact with the descending-side slide bush 9 (precisely, repeat of contact associated with the approach and the recession), the restriction protrusion 101 is gradually compressively deformed such that the protruding length with respect to bottom surface 34b is reduced. As described above, by the protruding length of the descending-side slide bush 9, the distance between the flange 92 of the descending-side slide bush 9 and the bottom surface 34b and the capacity of the grease storage portion 34d at the time that the descending-side slide bush 9 comes close to the bottom surface 34b are controlled. Therefore, since the protruding length is gradually reduced due to the repeated contact, the distance between the flange 92 of the descending-side slide bush 9 and the bottom surface 34b is gradually reduced and the capacity of the grease storage portion 34d is gradually reduced. As a result, during the repeated contact, the grease B in the grease storage portion 34d is gradually supplied between the end face 91a of the descending-side slide bush 9 and the bottom surface 34b of the descending-side housing portion 34 and between the end face 91a and the restriction protrusion 101 by the reduce amount of the capacity of the grease storage portion 34d. It can be said that the restriction protrusion 101 is compressively deformed with an increase in the number of contacts such that the protruding length is reduced.

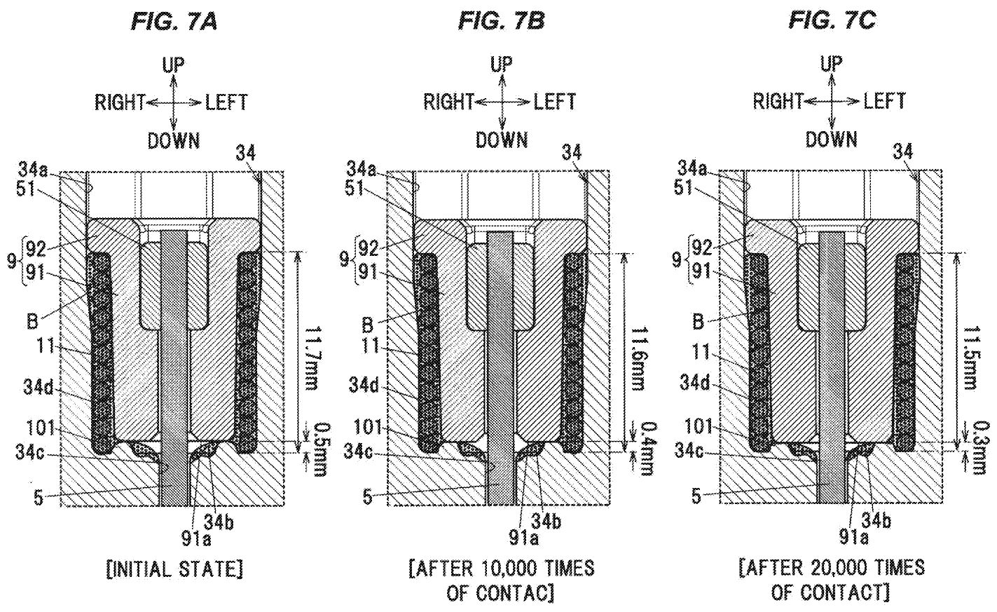

FIG. 7 shows cross sectional views a portion around the descending-side housing portion 34, showing deformation of the restriction protrusion 101 due to the repeated contact. In the initial state, the protruding length of the restriction protrusion 101 is 0.5 mm and the distance between the flange 92 of the descending-side slide bush 9 and the bottom surface 34b is 11.7 mm, as shown in FIG. 7A. Then, after the descending-side slide bush 9 and the restriction protrusion 101 come into contact with each other 10,000 times, the apex 101a of the restriction protrusion 101 is compressively deformed and recessed and the protruding length of the restriction protrusion 101 becomes 0.4 mm, as shown in FIG. 7B. Consequently, the distance between the flange 92 of the descending-side slide bush 9 and the bottom surface 34b becomes 11.6 mm and the capacity of the grease storage portion 34d is reduced. Then, after coming into contact 20,000 times, the apex 101a of the restriction protrusion 101 is further compressively deformed and recessed and the protruding length of the restriction protrusion 101 becomes 0.3 mm, as shown in FIG. 7C. Consequently, the distance between the flange 92 of the descending-side slide bush 9 and the bottom surface 34b becomes 11.5 mm and the capacity of the grease storage portion. 34d is further reduced. During 20,000 times of contact, the grease B in the grease storage portion 34d continues to be gradually supplied between the end face 91a of the descending-side slide bush 9 and the bottom surface 34b of the descending-side housing portion 34 and between the end face 91a and the restriction protrusion 101 by the reduce amount of the capacity of the grease storage portion 34d.

The amount of deformation of the restriction protrusion 101 (reduction in the protruding length) per contact is set considering the amount of grease that is supplied between the end face 91a of the descending-side slide bush 9 and the bottom surface 34b of the descending-side housing portion 34 in association with reduction in the capacity of the grease storage portion 34d. That is, the amount of deformation of the restriction protrusion 101 per contact is set so that the amount of grease supplied between the end face 91a and the bottom surface 34b is an amount sufficient to suppress abnormal noise at the time of the contact. The restriction protrusion 101 is formed with dimensions (width, length, etc. j so that this set amount of deformation per contact is satisfied. As a result, the restriction protrusion 101 is deformed by the repeated contact so that the capacity of the grease storage portion 34d is gradually reduced and the grease B in an amount sufficient to suppress abnormal noise at the time of the contact continues to be supplied from the grease storage portion 34d.

### Functions and Effects of the Embodiment

In the embodiment described above, during the repeated contact between the descending-side slide bush 9 and the restriction protrusion 101, the restriction protrusion 101 is gradually compressively deformed and consequently the grease B in the grease storage portion 34d is gradually supplied between the end face 91a of the descending-side slide bush 9 and the bottom surface 34b. As a result, when the window regulator 1 is used for a long period of time, it is possible to continuously supply the grease B between the end face 91a of the descending-side slide bush 9 and the bottom surface 34b and possible to suppress depletion of the grease B between the end face 91a and the bottom surface 34b. Therefore, even when the window regulator 1 is used for a long period of time, it is possible to suppress generation of abnormal noise due to contact between the descending-side slide bush 9 and the restriction protrusion 101.

In addition, since surface-to-surface contact between the end face 91a of the descending-side slide bush 9 and the bottom surface 34b can be avoided by the restriction protrusion 101, the phenomenon in which the grease B is actively pushed out through the lead-out groove 33c as in a syringe can be suppressed when the descending-side slide bush 9 comes close to the bottom surface 34b. As a result, it is possible to suppress outflow of the grease B through the lead-out groove 34c.

Further, since the restriction protrusion 101 extends so as to surround the bottom portion 34e of the lead-out groove 34c, it is possible to suppress the phenomenon that the grease B reaches the lead-out groove 34c by bypassing the restriction protrusion 101 and flows to the outside.

Furthermore, since the lateral surface 101b of the restriction protrusion 101 is an inclined surface, the grease B can be guided to the apex 101a (the contact surface) of the restriction protrusion 101.

### Other Embodiments

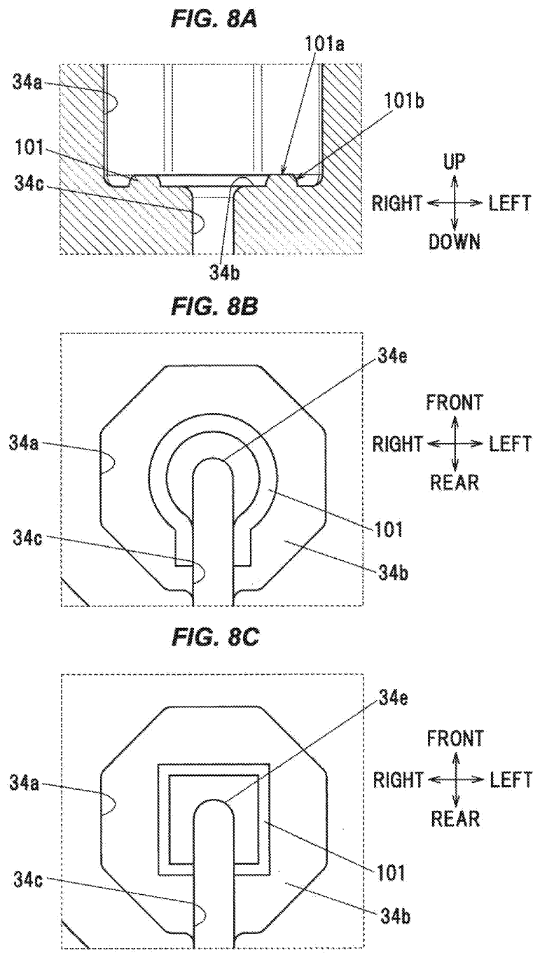

Although the restriction protrusion 101 in the embodiment described above has a semicircular cross-sectional shape, the restriction protrusion 101 may have, e.g., a semicircular cross-sectional shape without the apex 101a, as shown in FIG. 8A. That is, the contact surface with the descending-side slide bush 9 may be a flat surface facing the end face 91a. Furthermore, the restriction protrusion 101 may have a square cross-sectional shape, a triangular cross-sectional shape or a trapezoidal cross-sectional shape.

In addition, although the restriction protrusion 101 in the embodiment described above extends in an annular shape having a cut-out portion at the intersection with the lead-out groove 34c, the restriction protrusion 101 may be configured to, e.g., extend in an annular shape having a cut-out portion at the intersection with the lead-out groove 34c and then extend from the intersection along the lead-out groove 34c, as shown in FIG. 8B. Furthermore, the restriction protrusion 101 may extend in a rectangular shape having a cut-out portion at the intersection with the lead-out groove 34c, as shown in FIG. 8C.

Although the restriction protrusion 101 in the embodiment described above is compressively deformed by the repeated contact with the descending-side slide bush 9, it is not limited to compressive deformation as long as it is deformed so that the protruding length is reduced. For example, the restriction protrusion 101 may be curved and deformed or bent and deformed by the repeated contact so that the protruding length is reduced, or the restriction protrusion 101 may be abraded (worn away) by the repeated contact so that the protruding length is reduced.

In addition, although the restriction protrusion 101 in the embodiment described above is formed on the bottom surface 34b of the descending-side housing portion 34, the restriction protrusion 101 may be formed on the end face 91a (of the main body 91) of the descending-side slide bush 9. In this case, the restriction protrusion 101 protrudes from the end face 91a, comes into contact with the bottom surface 34b of the descending-side housing portion 34, and restricts the advancing position of the descending-side slide bush 9.

Furthermore, the restriction protrusion 101 is formed on a portion around the descending-side housing portion 34 in the embodiment described above, the restriction protrusion 101 may be also formed on a portion around the ascending-side housing portion 33. That is, the restriction protrusion 101 for restricting the advancing position of the ascending-side slide bush 8 may be formed on the bottom surface 33b of the ascending-side housing portion 33 or on the end face 81a (of the main body 81) of the ascending-side slide bush 8. In this case, the grease storage portion 34d in the ascending-side housing portion 33 is formed between the flange 82 of the ascending-side slide bush 8 and the bottom surface 33b of the ascending-side housing portion 33.

In addition, the amount of deformation of the restriction protrusion 101 per contact and the dimensions of the restriction protrusion 101 based on it are preferably changed according to the grease storage amount per unit height in the grease storage portion 34d. For example, since the grease storage amount per unit height in the grease storage portion 34d changes depending on, e.g., a thickness of a wire of the descending-side spring 11 arranged in the grease storage portion 34d, the amount of deformation of the restriction protrusion 101 per contact and the dimensions of the restriction protrusion 101 based on it are changed according to such a grease storage amount.

Although the invention is applied to the single-rail window regulator 1 in the embodiment described above, the invention may be applied to a double-rail window regulator or a rail-less window regulator as long as it is a wire-type window regulator.

Although the embodiment of the invention has been described, the invention according to claims is not to be limited to the embodiment. Further, please note that all combinations of the features described in the embodiment are not necessary to solve the problem of the invention. The invention can be appropriately modified and implemented without departing from the gist thereof.

### REFERENCE SIGNS LIST

1 WINDOW REGULATOR
3 CARRIER PLATE
5 DESCENDING-SIDE WIRE
9 DESCENDING-SIDE SLIDE BUSH
11 DESCENDING-SIDE SPRING
34 DESCENDING-SIDE HOUSING PORTION
34b BOTTOM SURFACE
34c LEAD-OUT GROOVE
34d GREASE STORAGE PORTION
34e BOTTOM PORTION
91 MAIN BODY
91a END FACE
92 FLANGE
101 RESTRICTION PROTRUSION
101a APEX
101b LATERAL SURFACE
B GREASE
G WINDOW GLASS

1. A window regulator, comprising:
a carrier plate to be attached to a vehicle window glass;
a wire to pull the carrier plate;
a slide member comprising a main body attached to an end of the wire and a flange at a base end of the main body; and
a spring to apply a tensile force to the wire,
wherein the carrier plate comprises a housing portion formed in a bottomed hole shape comprising a bottom surface on which a lead-out portion for leading out the wire is formed, the housing portion accommodating the slide member so that the slide member can advance and retreat and an end face of the main body faces the bottom surface, and the housing portion accommodating the spring in a compressed state between the flange and the bottom surface,
wherein a grease storage portion for storing grease is formed between the flange and the bottom surface,
wherein a protruding portion is formed on one surface out of the bottom surface and the end face so as to protrude from the one surface and comes into contact with the other surface out of the bottom surface and the end face to restrict an advancing position of the slide member, and
wherein the protruding portion is deformed by the contact such that a protruding length thereof is reduced.

2. The window regulator according to claim 1, wherein the protruding portion is formed on the bottom surface and comes into contact with the end face.

3. The window regulator according to claim 1, wherein the protruding portion is formed so as to surround at least a part of the lead-out portion.

4. The window regulator according to claim 1, wherein the protruding portion comprises a contact surface coming into contact with the other surface, and an inclined surface for guiding the grease stored in the grease storage portion to the contact surface.
